(19) United States
(12) Patent Application Publication
(10) Pub. No.: US 2025/0307900 A1
(43) Pub. Date: Oct. 2, 2025

(54) METHOD AND SYSTEM FOR PROCESSING INTERACTIVE MESSAGE ON SOCIAL PLATFORM

(71) Applicants: SHENZHEN DOUXUN NETWORK TECHNOLOGY CO., LTD., Shenzhen (CN); SHENZHEN MEIYUNJI NETWORK TECHNOLOGY CO., LTD., Shenzhen (CN)

(72) Inventors: Zhichao WANG, Shenzhen (CN); Zihao OU, Shenzhen (CN); Fan YANG, Shenzhen (CN); Jian YANG, Shenzhen (CN); Ling XIE, Shenzhen (CN); Nengting JIANG, Shenzhen (CN); Zhengye ZHANG, Shenzhen (CN)

(73) Assignees: SHENZHEN DOUXUN NETWORK TECHNOLOGY CO., LTD., Shenzhen (CN); SHENZHEN MEIYUNJI NETWORK TECHNOLOGY CO., LTD., Shenzhen (CN)

(21) Appl. No.: 19/092,105

(22) Filed: Mar. 27, 2025

(30) Foreign Application Priority Data
Mar. 29, 2024 (CN) 202410369944.X

(51) Int. Cl. G06Q 30/0601; G06F 40/205; G06F 40/279; G06Q 10/087; H04L 51/216; H04L 51/52

(52) U.S. Cl. CPC G06Q 30/0631; G06F 40/205; G06F 40/279; G06Q 10/087; H04L 51/216; H04L 51/52

(57) ABSTRACT

A method and system for processing interactive message on a social platform. The method includes: obtaining target product information, creating an information matching table, and establishing a corresponding relationship between keywords in the information matching table and the target product information; obtaining interactive message generated by live broadcasts, and in response to that the interactive message include keywords in the information matching table, adding the interactive message to a message queue and forming a queue message; grouping the queue messages according to the target user ID, and in response to the queue messages including same contents, retaining the queue message with an earliest or a latest generation time; and processing interactive message including multiple keywords, and selecting highly correlated keywords to send corresponding transaction links.

### TECHNICAL FIELD

The present application relates to the technical field of computer, and in particular to a method and a system for processing interactive message on a social platform.

### BACKGROUND

With the rise of global e-commerce, international retail trade has expanded rapidly. A large number of small and medium-sized e-commerce sellers have extended their retail business to foreign markets, selling domestic products through overseas e-commerce platforms. With the development of cross-border business, e-commerce enterprise resource planning (ERP) systems, developed based on traditional ERP software, have also evolved. E-commerce ERP systems can integrate deeply with e-commerce platforms, enabling domestic small and medium-sized e-commerce sellers to manage their overseas stores in a unified manner, overcome language barriers, and allow a single operator to manage hundreds of e-commerce stores simultaneously, significantly improving operational efficiency.

E-commerce ERP systems access and control stores on e-commerce platforms through predefined rules and process dynamic data across all aspects of store operations. The complexity of data management must also accommodate the operational convenience needs of different types of users (sellers). As a result, the functional modules of existing commercial e-commerce ERP systems are still undergoing continuous updates and improvements. Various software companies develop their own e-commerce ERP systems with different functional algorithms and rules, and as user demands evolve, new versions of each functional module are continually introduced to support more usage scenarios.

In the commodity sales process, e-commerce sellers increasingly use live broadcasts on social platforms to boost sales. While current e-commerce ERP systems can connect with social platforms to perform operational controls, they are unable to identify potential buyers based on interactive message during live broadcasts or push transaction-related information to buyers who send interactive message.

Other technical problems related to the present application will be further described later. The above content is intended to facilitate an understanding of the technical solution of the present application and does not imply that all of the above content is prior art.

### SUMMARY

The main objective of the present application is to provide a method and a system for processing interactive message on a social platform, so as to obtain potential transaction objects (potential buyers) from interactive message on the social platform based on an e-commerce ERP system, and accurately push commodity transaction information to potential buyers.

In order to achieve the above objective, the present application provides a method for processing interactive message on a social platform, which is used in an order module of an e-commerce ERP system or an e-commerce platform system. The method includes the following steps:
S1, obtaining data access permission of a target store, and obtaining at least one target product information of the target store, creating an information matching table including at least one keyword, and establishing a corresponding relationship between the keyword and the target product information according to a preset requirement;
S2, establishing a connection with a social platform, and monitoring a live broadcast status of the social platform, in response to that the social platform performs live broadcasting, obtaining an interactive message generated by live broadcast, and a message generation time and a target user ID of the interactive message;
S3, parsing the interactive message and matching the parsed interactive message with the information matching table, in response to that the interactive message match keywords in the information matching table, adding the interactive message to a message queue to form a queue message, and in response to that the interactive message do not match keywords in the information matching table, skipping adding the interactive message to the message queue;
S4, grouping, within a preset time, the queue message according to the target user ID, and in response to that the grouped queue message includes same contents, retaining the queue message with an earliest or a latest generation time; and
S5, determining a number of keywords in the queue message, in response to that the queue message includes a single keyword, determining corresponding target product information based on a corresponding relationship of the keyword, generating a transaction link according to the target product information, and sending the transaction link to a target user with a corresponding target user ID; and in response to that the queue message includes multiple keywords, calculating a relevance between each keyword and the queue message of a corresponding group, selecting a keyword with a highest relevance, determining corresponding target product information based on the corresponding relationship of the keyword, generating a transaction link according to the target product information, and sending the transaction link to the target user with the corresponding target user ID, the relevance is calculated based on a frequency of the keyword appearing in a sampled queue message.

Other features and technical effects of the present application are described in the following part of the specification. The ideas for solving the technical problem and related product design solutions of the present application are:

The applicant found that a large number of interactive messages are generated during the live broadcast, but these interactive messages are not well utilized. If the interactive message generated during the live broadcast can be obtained through ERP, they can be classified and processed, the interactive message related to the products can be extracted, and the user account information (such as user ID, etc.) that sent these messages can be obtained, then it is possible to screen out potential buyers from these users who sent interactive message, and infer the products that these potential buyers may be interested in, and then push the corresponding product transaction links to potential buyers through e-commerce ERP.

Therefore, the applicant provides a method for automatically generating commodity transaction links based on interactive message and pushing them to potential buyers. First, an information matching table is created in the order module of the e-commerce ERP. Keywords corresponding to various commodities (commodities for which transaction links are desired to be pushed) are configured in the information matching table, so that the keywords are associated with the corresponding commodity information of the e-commerce platform store. At the same time, the access rights of the social platform are obtained so that the interactive message generated by the social platform can be obtained by the ERP system and then matched with the keywords in the information matching table. Then, the successfully matched interactive message are used to generate transaction links.

The applicant also found that when users send interactive message, there may be many repeated interactive messages. Therefore, in the order module, the interactive messages are grouped and processed according to the target user ID; when there are repeated interactive message, the interactive message with the earliest message generation time or the latest message generation time is retained for generating transaction links. The interactive message used to generate the transaction link is added to the message queue.

In an embodiment, the applicant has found that when different keywords appear in an interactive message, each keyword will correspond to a different product. At this time, there may be a situation where multiple product transaction links may be pushed for one interactive message. Therefore, the priority of different products is further determined in the order module. By calculating the relevance between the keyword and other interactive message (sampled messages) respectively, and determining the relevance between the corresponding keyword and the sampled message, it is inferred that the product information corresponding to which keyword is more desired by the target user.

In an embodiment, when the message queue includes only a single keyword, the corresponding target product information can be determined based on the correspondence between the keyword and the target product information, and a transaction link is generated based on the target product information. When the message queue includes multiple keywords, the relevance between each keyword and the queue message of the corresponding group is calculated respectively, and the corresponding target product information is determined based on the correspondence between the keyword with the highest relevance and the target product information, and a transaction link is generated based on the target product information. Finally, the transaction link is sent to the target user with the corresponding target ID.

The method for processing interactive message on social platforms can help sellers effectively and accurately obtain potential transaction objects (potential buyers) from interactive message, and accurately push product transaction information to each potential buyer. It realizes interactive message based on the live broadcast platform, automatically generates product transaction links, greatly improves the efficiency of product promotion, and in the process of product promotion, no additional advertising promotion costs will be incurred on the e-commerce platform or the live broadcast platform, and the cost of product promotion is extremely low. In addition, because the ERP system is combined with the social platform, and transaction links are generated based on the target users of the interactive message, the ERP system can accurately count the calls of the product transaction links, and can timely obtain the target user's click and access data, as well as the generation and transaction information of temporary orders, thereby improving the statistical accuracy of information such as order conversion rate and revenue for each live broadcast event. Other implementation plans and technical effects are described later.

The present application further provides a system, the system is an e-commerce ERP system or an e-commerce platform system, and the system includes an order module or a social e-commerce module, and the order module or the social e-commerce module performs the operations in the method for processing interactive message on the social platform as described above.

In addition, the present application further provides a computer device, which includes a memory and a processor. The e-commerce ERP system or e-commerce platform system in the present application is stored in the memory, and the processor can run the operating instructions of the e-commerce ERP system or e-commerce platform system and execute the function implementation methods of each functional module.

The meaning and description of the terms in the field of e-commerce in the present application (the letters other than English words and field symbols in the present application are not case-sensitive):

1. Enterprise Resource Planning (ERP) is a management platform that is based on information technology and uses systematic management ideas to provide decision-making and operational means for enterprise decision-makers and employees. It can also be used as the abbreviation of ERP system in the present application.

2. Server Sent Events (SSE) is a technology based on sending only text messages from the server to the client in a WEB application; Application Programming Interface (API); Non-blocking I/O: refers to executing functions asynchronously, executing synchronous tasks first, and placing time-consuming tasks in the event queue for polling execution.

### BRIEF DESCRIPTION OF THE DRAWINGS

The accompanying drawings are used to provide further understanding of the present application and do not constitute a limitation of the present application; the contents shown in the accompanying drawings may be real data of the embodiments and belong to the protection scope of the present application.

FIG. 1 is a schematic diagram of a connection between an e-commerce Enterprise Resource Planning (ERP) system and a social platform according to an embodiment of the present application.

FIG. 2 is a schematic diagram of a system for processing interactive message on a social platform according to an embodiment of the present application.

FIG. 3 is a schematic diagram of a process sequence of a method for processing interactive message on a social platform according to an embodiment of the present application.

FIG. 4 is a flowchart of the method for processing interactive message on a social platform according to an embodiment of the present application.

### DETAILED DESCRIPTION OF THE EMBODIMENTS

In order to make the purpose, technical solution and advantages of this application clearer, the following is a further description of the embodiments of this application through specific implementation methods combined with the accompanying drawings. It should be understood that the specific embodiments described here are only used to explain this application and are not used to limit this application.

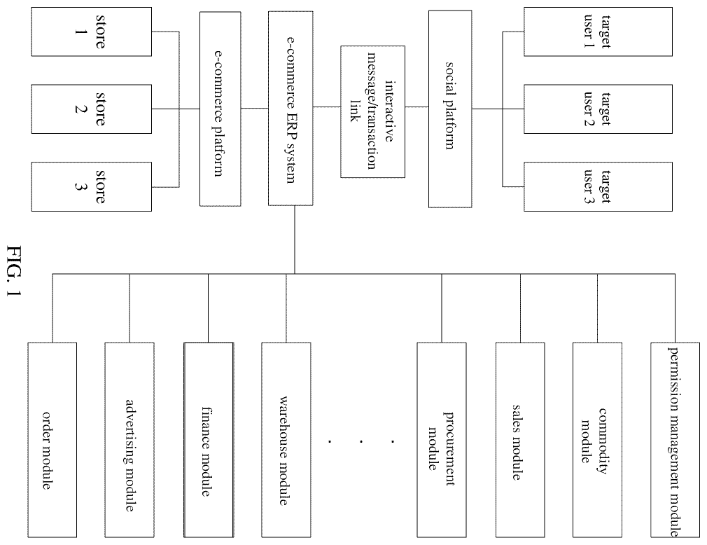

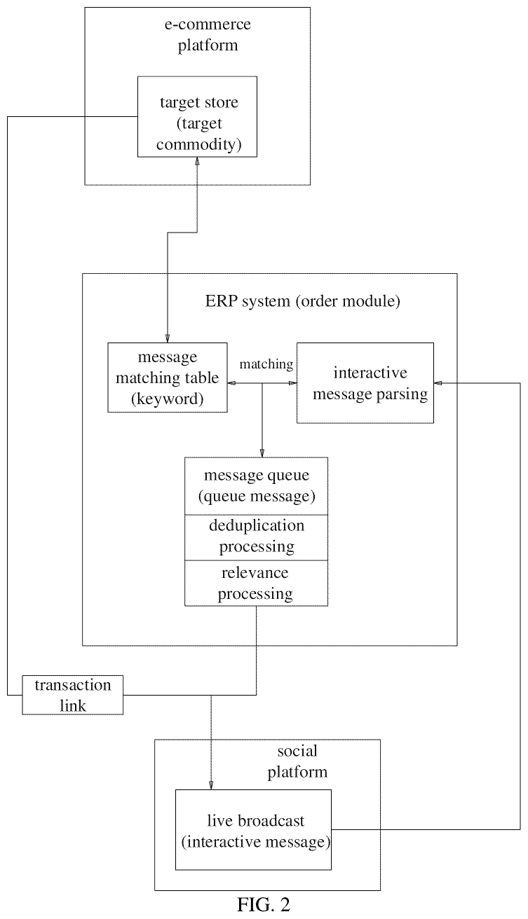

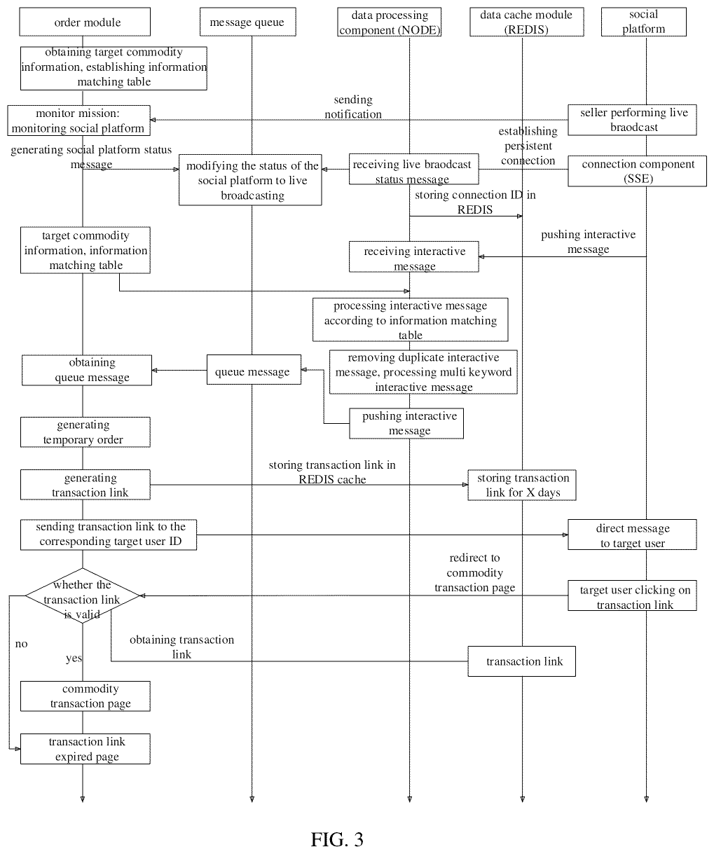

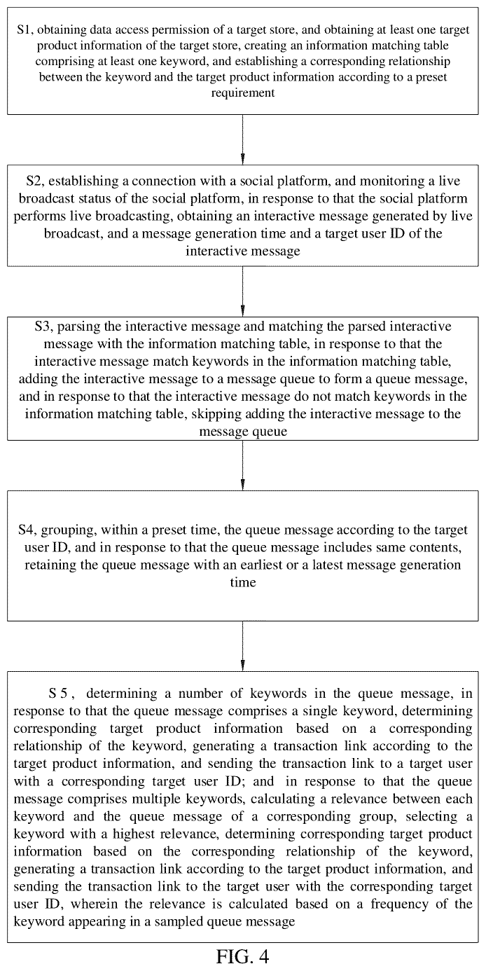

As shown in FIG. 1 to FIG. 4, an embodiment of the present application provides a method for processing interactive message on a social platform, which is used in an order module or a social e-commerce module of an e-commerce enterprise resource planning (ERP) system or an e-commerce platform system. The method includes steps S1-S5, which are specifically as follows.

S1, obtaining data access permission of a target store. The target store here refers to the online store opened by the seller after entering the e-commerce platform, which can also be called an e-commerce store. After establishing data interaction with the ERP system in the present application through the application programming interface (API) provided by the e-commerce platform, the ERP system can realize the operation and management of the e-commerce store. The next step is to create or obtain the product information of the target product based on the target store. When the e-commerce store has relevant information about the specific product, the corresponding transaction link, inventory and other information can be generated according to the product (information), and an information matching table can be created. The information matching table includes at least one keyword, and a mapping relationship between the keyword and the target product information is established according to preset requirements. For example, after establishing a mapping relationship between the keyword “mobile phone A” and the product “Xiaomi 14 mobile phone” in the store, the relevant information of “Xiaomi 14 mobile phone” can be found according to “mobile phone A”.

S2, establishing a connection with a social platform, and monitoring a live broadcast status of the social platform, in response to that the social platform performs live broadcasting, obtaining an interactive message generated by live broadcast, and a message generation time and a target user ID of the interactive message.

In an embodiment, the social platform is Facebook, and the corresponding commodity is broadcast live through Facebook. Other types of social platforms other than Facebook can also be applied. In order to push the corresponding commodity transaction link according to the interactive message (bullet message) of the social platform, the ERP system needs to be able to obtain the interactive message of the social platform, and then the cooperation of the data push module is required. Further, the data push module includes a connection component and a data processing component. The connection component establishes a persistent connection between the social platform and the data processing component. The data processing component processes the received interactive message based on the non-blocking I/O pattern and passes the interactive message to the message queue. The data processing component in this embodiment is Node.js, hereinafter referred to as Node. Node is used to create an HTTP server that receives, filters and processes interactive message; Node is a JavaScript runtime environment that calls the built-in API and is based on the Chrome V8 engine. The connection component in this embodiment is server sent events (SSE), which establishes a persistent connection with Facebook through SSE, and pushes the interactive message generated by Facebook during the live broadcast to the data processing component.

Specifically, when a social platform is live streaming a product and a large number of users (potential buyers) enter the live streaming room, it means that a large number of interactive message (bullet messages) will be generated during the live streaming of the product. At this time, when a large number of bullet messages are received synchronously, a lag phenomenon often occurs. That is, when interactive message is received synchronously, a large amount of network resources of the server will be occupied, and network congestion is likely to occur. The time required is the sum of all resource costs.

In an embodiment, in the processing of large amounts (concurrent) of interactive message (bullet messages), synchronous processing generally refers to actively requesting and waiting for I/O operations to be completed. Therefore, when the interactive message is ready, it is very easy to occupy network resources when reading and writing. At this time, if the load capacity of the bullet message processing service needs to be further improved, the number of servers needs to be increased, which will obviously increase a lot of financial costs. Asynchronous processing means that after actively requesting data, other tasks can continue to be processed, and then the corresponding actions can be performed after receiving the notification that the I/O operation is completed. This can prevent the process from being blocked when reading and writing data. That is, under the same network load, using data processing components can process multiple bullet messages at the same time, respond faster, and make full use of system resources.

In an embodiment, a persistent connection is established between the data processing component (Node) and the social platform through the connection component (SSE). Specifically, when interactive message (bullet message) is transmitted through the network, a connection must be established between the server and the client. When the message data transmission is completed and both parties no longer need the connection, they can release the connection. Network connection methods usually include short connections and long connections. Short connections are generally disconnected immediately after completing a data read and write. Since the establishment and disconnection of the connection require multiple handshakes, that is, it takes up a certain amount of system overhead. If the client connection requests are frequent or the data transmission volume is large, it will reduce the server processing speed and waste system resources and bandwidth, that is, it is not conducive to the timeliness of obtaining bullet messages. In an embodiment, live broadcasting is a continuous action, and after establishing a long connection based on the connection component, multiple connection establishment and closing operations can be omitted, thereby reducing the waste of network bandwidth and saving the time of receiving bullet messages, thereby ensuring the timeliness of data bullet message transmission and processing.

The ERP system cannot know when the social platform will be in working state (start live broadcast), so it monitors whether the social platform is live broadcasting. When the system monitors that the social platform is in live broadcasting state, that is, when Facebook starts live broadcasting, the bullet messages sent by potential buyers (Facebook participating users) in the social platform (live broadcast room) are pushed to the data processing component (NODE) through the long connection established by SSE, and the data processing component processes the interactive message accordingly. When pushing interactive message (bullet messages) one by one, the user ID and message generation time associated with the interactive message are also pushed at the same time, that is, the user ID under the Facebook platform.

S3, parsing the interactive message and comparing the interactive message with the information matching table. When the interactive message includes the keyword in the information matching table, it indicates that the interactive message is a valid interactive message and the user of the interactive message is a potential buyer (when the target user interacts with the message, it indicates that the target user may be interested in the product introduced by the e-commerce seller (streamer), so it is called a potential buyer). Further, add the interactive message to the message queue to form a queue message, and establish a mapping relationship between the queue message and the keyword. If the interactive message does not include the keyword, the interactive message will not be added to the message queue, that is, the relevant interactive message is determined as an invalid message, and the system will not perform a reply action.

The obtained bullet messages are filtered through the information matching table. In an embodiment, the bullet messages are matched through keywords; further, when there are multiple product information, assuming that there are products A, B, and C, three information matching tables A1, A2, and A3 can be created respectively. When the interactive message (bullet message) traverses the information matching tables A1, A2, and A3, and the interactive message matches any of the information matching tables, it means that the interactive message meets the conditions, and it will be retained and added to the message queue. In an embodiment, the message queue in the present application is based on KAFAK or PULSAR.

S4, grouping, within a preset time, the queue message according to the target user ID, and in response to that the queue message includes same contents, retaining the queue message with an earliest or a latest message generation time.

In actual live broadcast scenarios, due to some reasons (for example, to attract the attention of the streamer), some users participating in the live broadcast often send a large number of repeated interactive message in a short period of time. When these interactive messages become queue messages, that is, when these queue messages include keywords in the information matching table, the ERP system will push the transaction information of the corresponding commodities to these queue messages, thereby wasting unnecessary network resources and computing resources. To solve this problem, the queue messages can be grouped and processed by the target user ID, and then the queue messages within a time span, such as 20 seconds, 15 seconds, 10 seconds, and 5 seconds are obtained according to the generation time of the queue messages. When there are more than two queue messages with the same content in a certain time period, the queue message with the earliest message generation time or the latest message generation time is retained, thereby reducing unnecessary network resources occupied by a large number of repeated pushes of queue messages.

S5, determining a number of keywords in the queue message, in response to that the queue message includes a single keyword, determining corresponding target product information based on a corresponding relationship of the keyword, generating a transaction link according to the target product information, and sending the transaction link to a target user with a corresponding target user ID. After the target user receives the message (transaction link) replied by the ERP system, the corresponding product can be further browsed or purchased.

In an embodiment, when the queue message includes multiple keywords, the relevance between each keyword and the queue message of the corresponding group is calculated respectively, the keyword with the highest relevance is selected, the target product information is determined based on the corresponding relationship of the keywords, and the transaction link is generated, and the transaction link is sent to the target user of the social platform according to the target user ID corresponding to the queue message. The relevance can be the frequency of the keyword appearing in the sampled queue message. The sampled queue message here is a queue message that is grouped based on the target user ID, or a queue message including multiple different target IDs obtained based on a preset time.

After the highly correlated keywords are determined, the queue message is modified, that is, the keywords with low relevance are deleted, or the keywords with high relevance are marked. After the ERP system receives the corresponding queue message and identifies the corresponding mark, the commodity information of the keyword corresponding to the mark is selected to generate a transaction link. In an embodiment, after the highly correlated keywords are determined, the keywords with low relevance in the interactive message are deleted, which can further improve the processing efficiency of the interactive message. The interactive message pushes transaction information for the keyword with the highest relevance, and after deleting the redundant keywords in the interactive message, the system can directly parse out a single keyword in the interactive message; and when marking the highly correlated keywords, in addition to parsing out the corresponding keywords first, the system also needs to further find the corresponding keywords according to the mark, or first identify whether the interactive message includes a mark, and then find the corresponding keyword based on the mark. It can be seen that after the keywords are determined, other keywords are deleted at the same time, which can improve the system's push efficiency for transaction information.

In an embodiment, the calculation of the relevance between the keyword and the sampled queue message is based on the following formula: RD(m,n)=WF*log(X/df(m,n)); where WF represents the number of times the keyword m or n appears in the interactive message, X represents the total number of interactive message involved in the calculation, and df(m,n) represents the number of interactive message including the keyword m or n. When the calculated relevance RD value is relatively large, it means that the keyword is common in multiple sampled interactive messages, and the keyword is then selected and the corresponding transaction link is generated.

In an embodiment, queue messages are obtained one by one and user verification is performed. When the verification is successful, a temporary order for the target product is generated based on the target product information, that is, after the keywords in the interactive message match the information matching table of a certain product, a temporary order for the corresponding product is generated. The text information of the transaction link is generated according to the temporary order, and the transaction link is sent to the target user (Facebook user) in the social platform (live broadcast room) according to the user ID corresponding to the queue message. The generated temporary order can help sellers to accurately count the order transaction status and order conversion rate of the live broadcast, and then adjust the marketing strategy according to the statistical data.

In an embodiment, the ERP system generates a task to monitor whether the live broadcast is in progress. When the seller starts the live broadcast from the social platform (Facebook), a message is sent to the monitoring task on the ERP system. After the monitoring task receives the notification, it notifies the message queue to start (receive the message). At the same time, when the live broadcast is started, after the data processing component (NODE) and the social platform (Facebook) are established based on SSE, the data processing component will also send a live broadcast task message to the message queue, that is, it indicates that the API of the e-commerce ERP system and the social platform (Facebook) has been successfully connected. In an embodiment, the interactive message (bullet message) generated by the social platform (Facebook) are directly pushed to the data processing component (NODE) through the established persistent connection channel, and the interactive message after matching and processing by the information matching table are sent to the message queue and form queue messages. In an embodiment, the ERP system obtains the queue message and generates a temporary order and a transaction link corresponding to the temporary order, and also obtains the buyer ID of the social platform (Facebook) corresponding to the queue message (bullet message). The generated transaction link will be stored in the data cache module (REDIS). Finally, the ERP system sends the generated transaction link to the corresponding user (target user or potential buyer) of the social platform (Facebook) according to the buyer ID.

This method for processing interactive message on social platforms and the corresponding system, based on the data processing component providing data interaction services for the ERP system and the social platform, further coordinates and establishes a persistent connection between the data processing component and the social platform, thereby ensuring that in large flow scenarios, the ERP system and the live broadcast platform occupy lower network resources, that is, reducing the network load when the ERP system interacts with the live broadcast. Through the cooperation of the message queue, the real-time acquisition and timely processing of the bullet messages are ensured, thereby solving the problem of the ERP system's processing speed for interactive message on the live broadcast platform and the accuracy of message push (reply) in the large flow scenario during live broadcast. In addition, through the statistics of the ERP system's calls to the commodity transaction links (as well as the statistics of the temporary orders generated), accurate statistics of the order volume and other information of the live broadcast platform are achieved, thereby further improving the management efficiency of the ERP system for the store.

In an embodiment, queue messages are obtained one by one, and a temporary order of the target product is generated based on the product information of the target product, and a transaction link is generated according to the temporary order. After the temporary order is generated, the ERP system can calculate the live broadcast revenue of the corresponding product through the generation volume of temporary orders, the inventory occupancy of temporary orders, the number of orders actually completed, and the actual inventory consumption.

In an embodiment, the method for processing interactive message on a social platform further includes loading a data cache module, and storing the connection ID between the data processing component and the social platform through the data cache module, or in other words, the connection ID is used to enable data communication between the ERP system and the social platform (Facebook). Assuming that the ERP system has established data communication with the social platform (Facebook), due to the crash or restart of the NODE service, or since the e-commerce ERP is restarted due to the release of a new function, the ERP system will be disconnected from the live broadcast room of the social platform (Facebook). At this time, after obtaining the saved connection ID from the data cache module, the connection between the social platform (live broadcast room) and the ERP system can be restored, thereby minimizing the bad experience brought to users due to the disconnection. Conversely, in the absence of a connection ID, the previously connected live broadcast room and the ERP system cannot be re-established (restored), and it is necessary to restart a new live broadcast on the social platform and establish a connection with the ERP system. In other words, if the users (potential buyers) who originally participated in the live broadcast want to continue to participate in the seller's live broadcast activities, they need to exit the disconnected live broadcast room and re-enter the newly established live broadcast, which will undoubtedly bring a bad experience to the users (potential buyers) participating in the live broadcast.

In an embodiment, the method for processing interactive message on a social platform further includes loading a data cache module, storing the generated transaction link through the data cache module, and/or configuring an effective period for each transaction link based on the data cache module. Further, by saving the transaction link through the data cache module, on the one hand, the load balancing of data interaction between the ERP system and the social platform can be guaranteed, and on the other hand, the query speed of the data cache module is fast and the concurrent processing speed is high, thereby guaranteeing the processing efficiency of interactive message (bullet messages). Secondly, for the transaction link sent by the system to the user of the social platform, due to various reasons, (Facebook) users will not open the transaction link in time and transfer to the corresponding transaction page, and in order to reduce unnecessary resource overhead, the generated transaction link is not saved for a long time. In an embodiment, the generated transaction link is only saved in the data cache module for seven days. The specific saving time can also be flexibly selected according to different usage requirements. On the contrary, when using a message queue, it is impossible to specify the effective time for the transaction link conveniently and effectively, and when these transaction links are regularly cleaned up by other methods, the scale of the system composition structure will increase.

In an embodiment, the method for processing interactive message on a social platform further includes monitoring the transaction link. When the target user of the social platform (Facebook) accesses the corresponding transaction link, it is determined whether the transaction link is within the validity period. If the transaction link is within the validity period, the transaction link can be extracted from Redis and redirect to the corresponding commodity transaction page in the ERP system according to the transaction link. If the transaction link exceeds the validity period, a prompt indicating that the transaction link is invalid is returned to the target user. After the transaction link exceeds the validity period, Redis will automatically delete the saved transaction link to reduce unnecessary network resource overhead; at the same time, when the handover link is deleted, Redis sends a transaction link deletion notification to the ERP system. Further, the ERP system marks the corresponding temporary order as invalid according to the transaction link deletion notification, so that the seller can accurately grasp which temporary orders are in an invalid state, and it is convenient for the seller to clean up the invalid temporary orders.

In an embodiment, when the target user of the social platform redirects to the commodity transaction page through the transaction link, the commodity transaction page is monitored. If the target user performs a payment operation, the quantity of the target commodity in the inventory corresponding to the target commodity in the commodity transaction page is locked; thereby avoiding the inability to complete the paid order due to the consumption of inventory due to the processing of other orders or links in the ERP system, that is, ensuring the transaction of the paid order.

In an embodiment, the method for processing interactive message on a social platform further includes creating a message introduction template, merging the message introduction template with the transaction link, and sending the merged transaction link to a target user of the social platform. The generated transaction link is often just a string of characters. When the target user of the social platform receives such information, he or she cannot obtain the specific meaning of the information, so the target user often does not access the transaction link and perform the access, which may lead to the loss of the transaction. After adding the corresponding message introduction to the transaction link, the meaning of the received information can be clarified to ensure the transaction rate of the order.

In an embodiment, the method for processing interactive message on a social platform further includes writing preset marking information into a temporary order, for example, adding a label of “live broadcast order” to the temporary order, thereby helping the seller to count the orders, that is, counting which orders are orders directed from the social platform (live broadcast), thereby facilitating the seller to calculate the revenue brought by the social platform.

The above are only some embodiments of the present application, and do not limit the scope of the present application thereto. Under the inventive concept of the present application, equivalent structural transformations made based on the description and drawings of the present application, or direct/indirect application in other related technical fields, are included in the scope of the present application.

What is claimed is:

1. A method for processing interactive message on a social platform, comprising:
obtaining data access permission of a target store, obtaining at least one target product information of the target store, creating an information matching table comprising at least one keyword, and establishing a corresponding relationship between the keyword and the target product information according to a preset requirement;
establishing a connection with a social platform and monitoring a live broadcast status of the social platform, in response to the social platform performing live broadcasting, and obtaining an interactive message generated by live broadcast and a message generation time and a target user ID of the interactive message;
parsing the interactive message and matching the parsed interactive message with the information matching table, in response to the interactive message matching keywords in the information matching table, adding the interactive message to a message queue to form a queue message, and in response to the interactive message not matching keywords in the information matching table, skipping adding the interactive message to the message queue;
grouping, within a preset time, the queue message according to the target user ID, and, in response to the grouped queue message comprising same contents, retaining the queue message with an earliest or a latest generation time; and
determining a number of keywords in the queue message, in response to the queue message comprising a single keyword, determining corresponding target product information based on a corresponding relationship of the keyword, generating a transaction link according to the target product information, and sending the transaction link to a target user with a corresponding target user ID; and, in response to that the queue message comprising multiple keywords, calculating a relevance between each keyword and the queue message of a corresponding group, selecting a keyword with a highest relevance, determining corresponding target product information based on the corresponding relationship of the keyword, generating a transaction link according to the target product information, and sending the transaction link to the target user with the corresponding target user ID, wherein the relevance is calculated based on a frequency of the keyword appearing in a sampled queue message.

2. The method of claim 1, wherein the sampled queue message is a queue message after grouping based on the target user ID or a queue message comprising multiple different target user IDs obtained based on a preset time.

3. The method of claim 1, further comprising:
establishing a persistent connection between the social platform and a data processing component through a connection component, wherein the data processing component processes the received interactive message based on a non-blocking I/O pattern.

4. The method of claim 3, further comprising:
monitoring the transaction link, and, in response to detecting that the target user of the social platform accesses the corresponding transaction link, determining whether the transaction link is within a validity period;
in response to determining that the transaction link is within the validity period, redirecting the target user to a corresponding product transaction page according to the transaction link; and
in response to determining that the transaction link exceeds the validity period, returning a transaction link invalidation prompt to the target user.

5. The method of claim 4, further comprising:
monitoring the product transaction page, and, in response to detecting that the target user performs a payment operation, locking a quantity of the target product in an inventory corresponding to the target product in the product transaction page.

6. The method of claim 1, further comprising:
obtaining the queue message and generating a temporary order for the target product based on the product information of the target product; and
generating the transaction link according to the temporary order.

7. The method of claim 3, further comprising:
loading a data cache module and temporarily storing a connection ID between the data processing component and the social platform through the data cache module.

8. The method of claim 7, further comprising:
loading the data cache module and storing the generated transaction link through the data cache module, and/or configuring a validity period for the transaction link stored in the data cache module.

9. The method of claim 1, further comprising:
creating a message introduction template, merging the message introduction template with the transaction link, and sending the merged transaction link to a target user of the social platform.

10. A system for processing interactive message, comprising:
an order module configured to execute operations in the method for processing interactive message of claim 1.
